(19) United States
(12) Patent Application Publication
(10) Pub. No.: US 2025/0126001 A1
(43) Pub. Date: Apr. 17, 2025

(54) Multi-Level Signaling Linearity Feedback and Adjustment

(71) Applicant: Altera Corporation, San Jose, CA (US)

(72) Inventors: Itamar Levin, Holon (IL); Kevan Andrew Lillie, Chandler, AZ (US)

(21) Appl. No.: 19/002,449

(22) Filed: Dec. 26, 2024

(51) Int. Cl. H04L 25/49; H04L 25/03

(52) U.S. Cl. CPC H04L 25/4917; H04L 25/03006; H04L 2025/03363; H04L 2025/03433; H04L 2025/0377

(57) ABSTRACT

Integrated circuit devices, methods, and circuitry for linearity feedback to enable signal adjustment in multi-level signaling communication are provided. A system may include a first integrated circuit device with transmitter circuitry to controllably adjust levels of a multi-level signal and transmit the multi-level signal over a communication link. The system may also include a second integrated circuit device with receiver circuitry to receive the multi-level signal and instruct the transmitter circuitry to adjust the levels of the multi-level signal.

### BACKGROUND

This disclosure relates to systems and methods for multi-level signaling communication between electronic devices with linearity feedback to enable signal adjustment.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Communication between different integrated circuits has become increasingly sophisticated to increase the rate that data is transferred from one electronic device to another electronic device. In some communication schemes, such as non-return-to-zero (NRZ), a transmitter circuit of a first electronic device sends a signal to a receiver circuit of a second electronic device that has symbols that can be one of two different voltage signal levels. One of the signal levels is interpreted by the receiver circuit as a “1” while the other signal level is interpreted as a “0.” To communicate even more data per symbol, some communication schemes apply multi-level signaling. Multi-level signaling communication schemes use symbols that can be one of several different signal levels. For example, pulse amplitude modulation (PAM)-4 includes symbols that can have one of four different signal levels. These four different voltage levels may be interpreted by the receiver circuit as “00,” “01,” “10,” or “11.”

Multi-level signaling is used in serial input-output (IO) specifications such as Peripheral Component Interconnect Express (PCIe) Gen 6 and 7, 100GBASE-CR1, OIF-CEI-112G-LR-PAM4 and future standards such as 200GBASE-KR1 use PAM-4, or higher, signal constellations. They are transmitted using multiple signal levels per unit interval to convey more information per time interval compared to NRZ signals. The receiver circuit may detect each signal level to decode all the transmitted information. The signal-to-noise ratio of each signal level affects the ability of the receiver to correctly identify each value. Although many receiver circuits can adjust the entire signal level swing upon receiving the signal to optimize it for its level detection circuits, the receiver circuit may be unable to adjust the levels of the intermediate signals to ensure maximum signal-to-noise ratio. Indeed, some receiver circuits may be able to apply a nonlinear distortion function at the receiver (e.g., an example for such function can be A-law or u-law distortions); however, these functions may be difficult to implement using high-speed analog circuits or may be costly to implement in the digital parts of the receiver circuit.

### BRIEF DESCRIPTION OF THE DRAWINGS

Various aspects of this disclosure may be better understood upon reading the following detailed description and upon reference to the drawings in which:

FIG. 1 is a block diagram of a system to enable communication between two integrated circuit devices with multi-level signaling linearity feedback;

FIG. 2 is an eye diagram of a four-level signal with symmetry between signal levels;

FIG. 3 is an eye diagram of a four-level signal with asymmetric signal levels;

FIG. 4 is a block diagram of the system illustrating measurement and adjustment of a multi-level signal constellation to correct for non-linearities in a transmitted signal;

FIG. 5 is a flowchart of a method for measurement and adjustment of a multi-level signal constellation to correct for non-linearities in a transmitted signal; and

FIG. 14 is a block diagram of a data processing system that may incorporate the systems and methods of this disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

As communication between different electronic devices increases in data rate, it becomes increasingly valuable to improve the signal-to-noise ratio (SNR). To improve the SNR in multi-level signaling communication schemes, a receiver circuit may measure the symmetry of the multi-level signals it is receiving and provide feedback to the transmitter to improve the linearity of the signal. The systems and methods of this disclosure leverages the ability of the receiver circuit to measure the linearity of the received signal levels, the ability to communicate requests to the link partner transmitter, and the ability of the transmitter to adjust its signaling levels. In essence, since the receiver circuit can measure the linearity or distortion of the received signal, it can communicate with the transmitter circuit to adjust the signal levels in a feedback loop. This is a very complementary process to the transmitter equalization adaptation that may be performed during Link Training used in Ethernet and PCIe, for example, and may be performed at the same time.

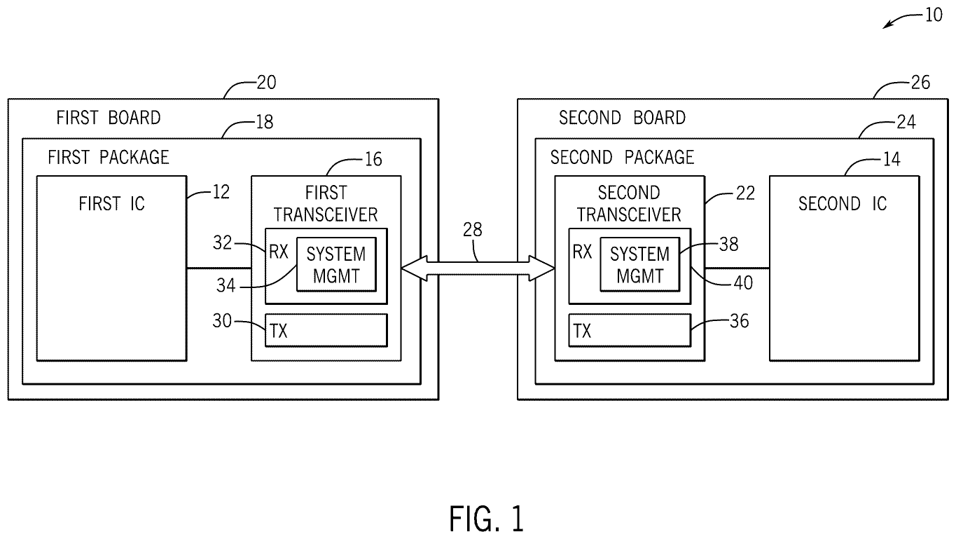

FIG. 1 illustrates a communication system 10 to enable communication between a first integrated circuit (IC) 12 and a second IC 14. The first IC 12 and the second IC 14 may be any suitable integrated circuits that may be in communication. For example, the first IC 12 and the second IC 14 may include programmable logic devices (PLDs), such as field programmable gate arrays (FPGAs), application specific integrated circuits (ASICs), processors (e.g., central processing units (CPUs), graphics processing units (GPUs)), artificial intelligence (AI) compute circuitry, memory or storage (e.g., random access memory (RAM), read only memory (ROM), nonvolatile memory, high-bandwidth memory (HBM)), or the like.

The first IC 12 may communicate using a first transceiver 16. In the example of FIG. 1, the first IC 12 and the first transceiver 16 are separate dies in a first package 18 on a first printed circuit board 20. In other examples, the first IC 12 and the first transceiver 16 may be part of a single monolithic integrated circuit. The first transceiver 16 may send communication to or receive communication from a second transceiver 22 in communication with the second IC 14. In the example of FIG. 1, these are also shown as separate dies in a second package 24 on a second printed circuit board 26. In other examples, the second IC 14 and the second transceiver 22 may be part of a single monolithic integrated circuit. A communication link 28 may include transmission lines from the first transceiver 16 to the second transceiver 22 and/or transmission lines from the second transceiver 22 to the first transceiver 16.

The first transceiver 16 may include a transmitter circuit (TX) 30 and a receiver circuit (RX) 32. System management circuitry 34 may manage communication received by the RX 32. The second transceiver 22 may include a transmitter circuit (TX) 36 and a receiver circuit (RX) 38. System management circuitry 40 may manage communication received by the RX 38. The system management circuitry 34 and/or the system management circuitry 40 may include any suitable control circuitry. For example, the system management circuitry 34 and the system management circuitry 40 may be implemented using one or more finite state machines (FSMs) in hardware or using one or more microcontrollers that execute firmware instructions.

Some protocols, such as Peripheral Component Interconnect Express (PCIe) and Ethernet, specify the locations of the system management circuitry 34 and 40. As such, in FIG. 1, the system management circuitry 34 is shown as a component of the RX 32 and the system management circuitry 40 is shown as a component of the RX 38. Other protocols, such as Optical Internetworking Forum-Common Electrical I/O (OIF-CEI), do not specify the location of the system management circuitry 34 and 40. As such, in other embodiments, the system management circuitry 34 and the system management circuitry 40 may be located elsewhere (e.g., the first IC 12, the second IC 14, on another integrated circuit in the first package 18 or the first board 20, on another integrated circuit in the second package 24 or the second board 26, or on a different board altogether).

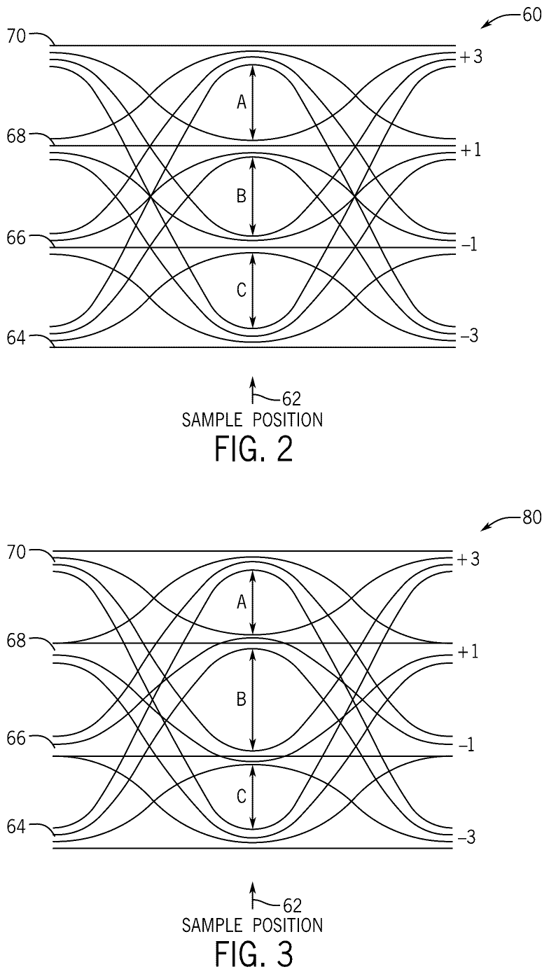

The first transceiver 16 may communicate with the second transceiver 22 using any suitable signaling protocol. While this disclosure will use examples with four-level pulse-amplitude-modulation (PAM-4) signals, other multi-level signaling schemes may be used with any suitable number of signal levels (e.g., PAM-N, where N represents any suitable pulse amplitude modulation integer). FIG. 2 is an eye diagram 60 of a PAM-4 signal that may be transmitted from the TX 30 of the first transceiver 16 to the RX 38 of the second transceiver 22. The eye diagram 60 illustrates a composite visualization of all of the possible PAM-4 signal levels and transitions when the PAM-4 signal is fully symmetrical. The RX 38 may measure the PAM-4 signal at a sample position 62 to determine whether the signal level represents a low level (V₋₃) 64, a low intermediate level (V₋₁) 66, a high intermediate level (V₊₁) 68, or a high level (V₊₃) 70. The term “eye” in the eye diagram 60 refers to the space between the four signaling levels (−3, −1, +1, +3) at the sample position 62. For best receiver signal margin and to ensure the best data integrity, eye heights shown as “A”, “B” and “C” may ideally all be equal and the “eyes” should be symmetric.

At the RX 38, each signal level 64, 66, 68, and 70 should be detected to decode all the transmitted information. The signal-to-noise ratio of each signal level affects the ability of the receiver to correctly identify each value. The correct spacing of the signal levels 64, 66, 68, and 70 across the swing range of the signal ensures the best signal integrity at the receiver level detection circuits. The RX 38 may adjust the entire signal level swing to optimize it for its level detection circuits to detect the signal levels 64, 66, 68, or 70. As will be discussed further below, the RX 38 may also communicate a control signal to the TX 30 to cause the TX 30 to adjust the levels of the intermediate signals sent by the TX 30 to improve the signal-to-noise ratio of the signal when it is received at the RX 38.

This is especially valuable because, as shown by an eye diagram 80 in FIG. 3, the signal levels 64, 66, 68, and 70 at the sample position 62 on the signal received by the RX 38 may not be symmetrical. The eye diagram 80 shows non-linear eyes where B>(A or C) in height. The ability of the RX 38 to discern between, for example, levels 68 and 70 (level −1 and level −3) is diminished by the non-linearity and reduced signal-to-noise ratio for these signal levels. Note that the RX 38 may be able to select where to put a signal slicer for levels 66 and 68 (level +1 and level −1), but to adjust these signal levels it may employ complex nonlinear transfer functions that are hard to implement. As such, the RX 38 may adjust the signal level of levels 64 and 70 (level +3 and level −3). Rather than attempt to adjust the levels 66 and 68 (level +1 and level −1) alone, the RX 38 may provide feedback to the TX 30 so that the TX 30 may adjust the signals before they are transmitted, resulting in a multi-level signal received at the RX 38 that is symmetrical. In other words, the systems and methods of this disclosure enables the RX 38 to effectively adjust the level of the signal levels 66 and 68 (level +1 and level −1) in a manner practical for implementation.

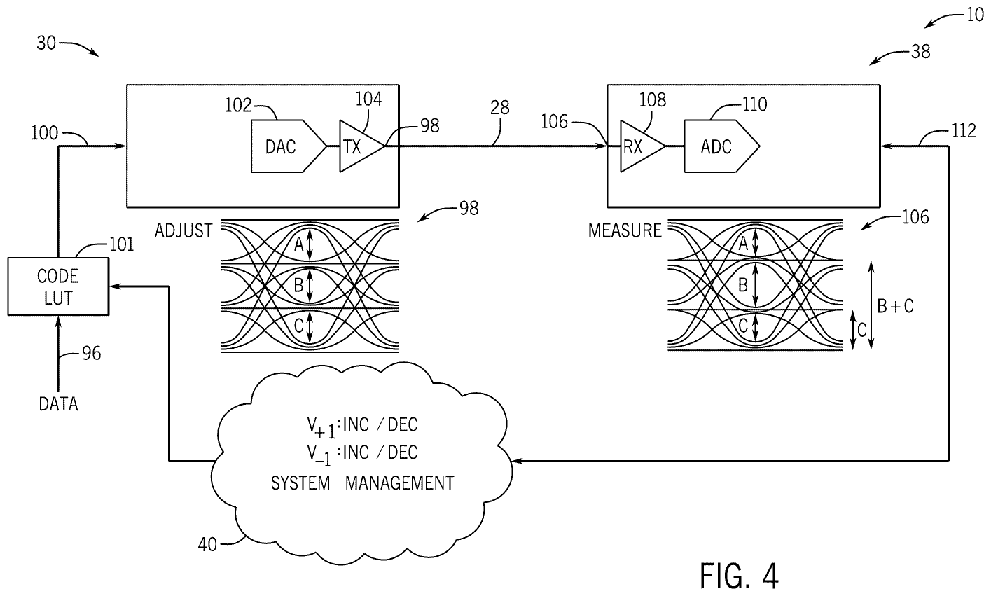

FIG. 4 is a block diagram of the system 10 illustrating a manner of improving the linearity and signal-to-noise ratio of multi-level signaling by providing an indication from the RX 38 to the TX 30 to adjust the intermediate level positions. The TX 30 may transmit data 96 that is converted to an outgoing analog multi-level signal 98 over the communication link 28 to the RX 38. The outgoing multi-level signal 98 may be represented by a digital signal 100, which may be generated when the data 96 is converted into digital values representing the levels using a code lookup table (LUT) 101. The digital signal 100 thus represents a digital form of the outgoing multi-level signal 98 that defines the signal levels in a digital manner. For example, the digital signal 100 may be an 8-bit signal with 8-bit codes that define the outgoing multi-level signal 98 based on 256 possible signal level positions. The digital signal 100 may be signed or unsigned depending on the implementation. To provide one specific example, level −3 may be defined by a code value 0 of a maximum of 255, level −1 may be defined by a code value 63 of a maximum of 255, level +1 may be defined by a code value 191 of a maximum of 255, and level +3 may be defined by a code value 255 of a maximum of 255. In other embodiments, the digital signal 100 may have more or fewer bits that are able to represent more or fewer discrete possible values for the multi-level signaling levels. The digital signal 100 is converted by a digital-to-analog converter (DAC) 102 into an analog representation of the multi-level signal 98 to be transmitted. The analog representation of the multi-level signal 98 may be amplified by a TX output driver 104 and transmitted across the communication link 28. In other embodiments, the TX 30 may employ different signal transmission techniques other than digital-to-analog conversion to generate the analog version of the multi-level signal 98 that is transmitted across the communication link 28.

At the RX 38, a received analog multi-level signal 106 may arrive at a receiver circuit 108 on the communication link 28. Notably, after traversing the communication link 28, the received analog multi-level signal 106 may have asymmetries in its eyes that could disrupt the ability of the RX 38 to properly distinguish the levels of the samples. An analog-to-digital converter (ADC) 110 may produce a digital signal 112 that provides a digital representation of the multi-level signal 106. The digital signal 112 may be processed by any suitable circuitry of the RX 38 to determine the information provided by the multi-level signal 106 based on the represented levels of each sample.

As illustrated in FIG. 4, the system management circuitry 40 may additionally provide feedback to the TX 30 to improve the symmetry of the received multi-level signal 106 by adjusting the outgoing multi-level signal 98. This leverages the ability of the RX 38 to measure the linearity of the signal levels of the received multi-level signal 106, the ability to communicate requests to the link partner TX 30, and the ability of the TX 30 to adjust its signaling levels (e.g., by adjusting the codes used by digital signal 100 to represent the various levels). In essence, since the RX 38 can measure the linearity or distortion of the received multi-level signal 106, it can communicate with the TX 30 to adjust the signal levels of the outgoing multi-level signal 98 in a feedback loop. Note that this may be performed during TX 30 equalization adaptation performed during Link Training (e.g., as used in Ethernet and PCIe) or at other times.

The system management circuitry 40 of the RX 38 may include data slicing measurements (e.g., three data slicers) and may measure the levels of the 3 data slicers and compare them to target levels based on a target (e.g., optimal) swing level into the RX 38. To a first order, the system management 40 of the RX 38 can use this information to determine eye linearity or, for a scrambled and balanced data stream, the equal distribution of the signal above and below the slicing target (e.g., constellation levels). The system management circuitry 40 may also perform a next level of measurement using error slicing levels (e.g., positioned at the 4 signal levels −3, −1, +1, +3) to compare to expected targets for them. Using the 3 data slicing levels and the 4 error slicing levels, the system management circuitry 40 now has a measurement of the linearity of the received multi-level signal 106.

The received multi-level signal 106 may be non-linear due to imperfections in the TX output driver 104, distortion and non-linearities of the communication link 28, and non-ideal behaviors of front-end filters of the receiver circuitry 108. Regardless of how it occurs, the received multi-level signal 106 linearity can be corrected by the TX 30 under guidance of the RX 38.

Note that, while the standard definitions for return loss margin (RLM) in the IEEE 802.3 and OIF-CEI specifications calculate a metric to evaluate transmitter output non-linearity against a specification, it is not believed that offer enough information for the non-linearity to be corrected. Also, a particular receiver implementation may use different methods to set slicing levels; however, a receiver may detect where the error slicer levels are relative to the target amplitude of the signal.

With this in mind, once the receiver circuitry 108 adjusts the +3 and −3 for improved (e.g., optimal) resolution of the ADC 110, the RX 38 can measure the voltage level of +1 and −1 signals (V₊₁ and V₋₁) of the received multi-level signal 106. If either or both are not sufficiently close to their targets given the position of the +3 and −3 signal levels, the system management circuitry 40 of the RX 38 may request the TX 30 to increment or decrement the various signal levels of the outgoing multi-level signal 98. For example, the system management circuitry 40 may send a control signal to the TX 30 (e.g., via a side channel, via a control frame, via the TX 36) to instruct the TX 30 to adjust the levels of the outgoing multi-level signal 98. Since the TX 30 may use certain codes of the digital signal 100 to define the levels, the system management circuitry 40 may instruct the TX 30 to increment or decrement the levels and the TX 30 may increment or decrement the codes used for the voltage levels of +1 and −1 signal levels (V₊₁ and V₋₁).

To provide one example, the system management circuitry 40 may determine that the B eye of the received multi-level signal 106 is asymmetric for being too large in relation to the A eye and the C eye. The system management circuitry 40 may instruct the TX 30 to increment the voltage level −1 and to decrement the voltage level +1. If the TX 30 has been using a code value 63 of a maximum of 255 to represent level −1 using the digital signal 100 and using a code value 191 of a maximum of 255 to represent level +1 using the digital signal 100, the TX 30 may receive the instruction from the system management circuitry 40 and increment the code for level −1 in the digital signal 100 to a higher value (e.g., 64) and decrement the code for level +1 in the digital signal 100 to a lower value (e.g., 190). Note that this is intended as a simplified example. In practice, the TX 30 may adjust the levels according to any suitable control scheme. For instance, an initial request to increment or decrement the levels may be treated as coarse-grained corrections that involve a greater change to a voltage level (e.g., incrementing level −1 from a digital code of 63 of 255 to a digital code of 71 of 255), and subsequent requests may be treated as fine-grained corrections that involve less change to a voltage level (e.g., incrementing level −1 from a digital code of 71 of 255 to a digital code of 72 of 255).

Once the TX 30 has made an adjustment to the outgoing multi-level signal 98, the RX 38 may re-adjust the +3 and −3 levels, readjust the equalization of the communication link 28 by both TX 30 and RX 38, and then re-evaluate the new +1 and −1 levels. If the system management circuitry 40 determines to request further adjustment, the system management circuitry 40 of the RX 38 may send additional control signals with requests to the TX 30 (e.g., one increment/decrement request at a time until the received multi-level signal 106 falls within a defined specification).

Thus, the TX 30 receives the individual level increment and decrement messages from the RX 38 and uses these requests to adjust its output levels when signaling at level +1 or −1. It may do this by adjusting the digital code LUT 101 or the operation of the DAC 102 (e.g., digital-to-analog converter look-up-tables which it may use to encode the signal at various levels for equalization). Additionally or alternatively, digital logic of the TX 30 that is used for transmitter equalization can apply a trim offset to the levels for each of the +1 and −1 levels and incorporate the applied equalization. In either case, the final outgoing multi-level signal 98, with equalization of the TX 30, may be adjusted to compensate for non-linearity or mis-proportionality in the received multi-level signal 106 as sampled by the RX 38.

The RX 38 may use any suitable technique to provide the instructions to the TX 30. For example, the RX 38 may issue a Control Frame (e.g., over Ethernet), or may coordinate the instructions using the system management circuitry 40 and/or 34 (e.g., as in OIF-CEI or PCIe). The messages to the TX 38 may identify which transmitter level (+1 or −1) is to be adjusted and whether it should be incremented or decremented. The exchanges of messages and the adjustments to the outgoing multi-level signal 98 may be performed during a training phase of the link establishment so as not to impact the bit error ratio of normal operations by perturbing the signal. This may be performed after an equalization adaptation phase of the link establishment to improve (e.g., maximize) the signal-to-noise ratio at the RX 38, allowing it to lock to the incoming received multi-level signal 106 and make good (e.g., the best) measurements of the signal linearity.

In one particular example, the RX 38 may send a message to increment or decrement a level based on cells of the Coefficient Update Field and/or the Status Report Field of the IEEE 802.3 Ethernet Specification (e.g., IEEE Std 802.3-2022). For example, cells 11:6 of the Coefficient Update Field and cells 14:6 of the Status Report Field have been marked as reserved. Some or all of these cells may be used to signal whether to increment or decrement a particular level. For instance, a control frame may use the cells 7:6 of the Coefficient Update Field to increment/decrement level −1 (e.g., 00=hold, 10=decrement, 01=increment, 11=reserved) and may use the cells 7:6 of the Coefficient Update Field to increment/decrement level +1 (e.g., 00=hold, 10=decrement, 01=increment, 11=reserved). Similarly, a control frame may use the cells 7:6 of the Status Report Field to retrieve a status of the position of level-1 (e.g., 00=not_updated, 01=updated, 10=minimum, 11=maximum) and may use the cells 7:6 of the Status Report Field to retrieve a status of the position of level +1 (e.g., 00=not_updated, 01=updated, 10=minimum, 11=maximum). Examples are shown in the tables below:

TABLE 1
Coefficient Update Field

| Cell(s) | Name | Description |
|---|---|---|
| 15:14 | Reserved | Transmitted as 0, ignored on reception. |
| 13 | Preset | 1 = Preset coefficients; |
| | | 0 = Normal operation |
| 12 | Initialize | 1 = Initialize coefficients; |
| | | 0 = Normal operation |
| 11:10 | Reserved | Transmitted as 0, ignored on reception. |
| 9:8 | Level +1 update | 00 = hold, 10 = decrement, |
| | | 01 = increment, 11 = reserved |
| 7:6 | Level −1 update | 00 = hold, 10 = decrement, |
| | | 01 = increment, 11 = reserved |
| 5:4 | Coefficient (+1) | 00 = hold, 10 = decrement, |
| | update | 01 = increment, 11 = reserved |
| 3:2 | Coefficient (0) | 00 = hold, 10 = decrement, |
| | update | 01 = increment, 11 = reserved |
| 1:0 | Coefficient (−1) | 00 = hold, 10 = decrement, |
| | update | 01 = increment, 11 = reserved |

TABLE 2
Status Report Field

| Cell(s) | Name | Description |
|---|---|---|
| 15 | Receiver ready | 1 = The local receiver has determined |
| | | that training is complete and is prepared |
| | | to receive data.; 0 = The local receiver |
| | | is requesting that training continue. |
| 14:10 | Reserved | Transmitted as 0, ignored on reception. |
| 9:8 | Level +1 update | 00 = not_updated, 01 = updated, |
| | | 10 = minimum, 11 = maximum |
| 7:6 | Level −1 update | 00 = not_updated, 01 = updated, |
| | | 10 = minimum, 11 = maximum |
| 5:4 | Coefficient (+1) | 00 = not_updated, 01 = updated, |
| | update | 10 = minimum, 11 = maximum |
| 3:2 | Coefficient (0) | 00 = not_updated, 01 = updated, |
| | update | 10 = minimum, 11 = maximum |
| 1:0 | Coefficient (−1) | 00 = not_updated, 01 = updated, |
| | status | 10 = minimum, 11 = maximum |

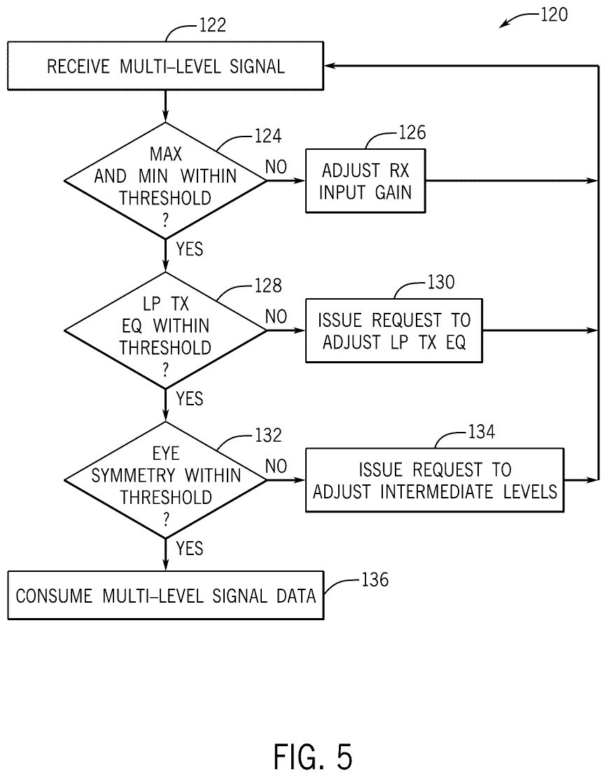

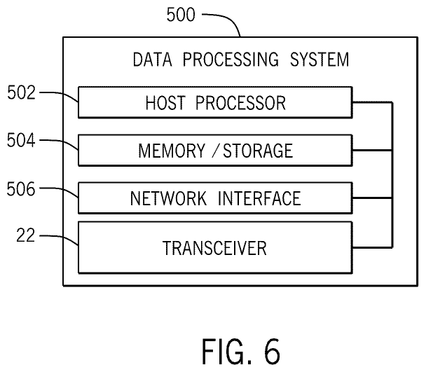

FIG. 5 is a flowchart 120 of a method that may be performed by the RX 38 to perform the measurements and adjustments of the received eye in relation to the TX 20 equalization adjustments. The flowchart 120 may be performed by the RX 38 (e.g., via the system management circuitry 40 or other control system) during link training to avoid reducing the bit error rate (BER) of subsequent data transfer, but the flowchart 120 may be performed at other times (e.g., after some period of communication). The flowchart 120 may begin as the RX 38 receives the multi-level signal 106 (process block 122). If the maximum and minimum levels (level −3 and level +3) of the multi-level signal 106 are not within threshold levels (decision block 124), the RX 38 may adjust the input gain of the receiver circuitry 108 (process block 126). Once the maximum and minimum levels (level −3 and level +3) of the multi-level signal 106 are within the threshold levels (decision block 124), the process may flow to decision block 128, where the RX 38 may determine whether a lowpass (LP) TX 30 equalization (EQ) is within specified thresholds. If not, the RX 38 may issue requests to adjust the equalization of the TX 30 (process block 130). If so, the process may flow to decision block 132, where the RX 38 may determine whether the eye symmetry and/or linearity is within specified thresholds. If not, the RX 38 may instruct the TX 30 in the manner mentioned above to cause the TX 30 to update the levels of the outgoing multi-level signal 98 (process block 134) before beginning to consume the data transmitted in the RX 38 (block 136). Note that it may be valuable to repeat the Input Gain and TX 30 equalization adjustments of process block 130 after the eye linearity has been adjusted in process block 134 and to repeat the loop until the input gain, equalization and linearity is satisfactory and falls within specified ranges (e.g., thresholds). The three eye heights A, B, and C may not be exactly equal or the V₊₁ and V₋₁ levels may not be perfectly at target levels, so some threshold of accuracy is determined based on the link error rate specification of the communication system 10 (e.g., as used by the system management circuitry 40). The exact method by which the RX 38 determines which level needs to be adjusted depends on the implementation of eye measurement metric employed by the RX 38.

Note also that TX 30 compliance tests specified by a serial I/O standard may be performed before this capability is enabled, since compliance test results may be impacted by the adjustment in a way that could mark the TX 30 as failing compliance tests.

The communication system 10 may be used in a data processing system, such as a data processing system 500, shown in FIG. 6. This may allow a high-speed transceiver of the data processing system 500 to improve multi-level signal communication. The data processing system 500 may include the transceiver 22, a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 14 may include the transceiver 22. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the transceiver 22. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the multi-level signaling system of this disclosure may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. A system comprising:
a first integrated circuit device comprising transmitter circuitry configured to controllably adjust levels of a multi-level signal and transmit the multi-level signal over a communication link; and
a second integrated circuit device comprising receiver circuitry configured to receive the multi-level signal and instruct the transmitter circuitry to adjust the levels of the multi-level signal.

EXAMPLE EMBODIMENT 2. The system of example embodiment 1, wherein the receiver circuitry is configured to instruct the transmitter circuitry to adjust the levels of the multi-level signal based on an eye symmetry of the multi-level signal as received by the receiver circuitry.

EXAMPLE EMBODIMENT 3. The system of example embodiment 1, wherein the receiver circuitry is configured to instruct the transmitter circuitry to adjust the levels of the multi-level signal using an increment or decrement signal to instruct the transmitter circuitry to increment or decrement an intermediate level of the multi-level signal.

EXAMPLE EMBODIMENT 4. The system of example embodiment 1, wherein the receiver circuitry is configured to transmit a control frame to the transmitter to instruct the transmitter circuitry to adjust the levels of the multi-level signal.

EXAMPLE EMBODIMENT 5. The system of example embodiment 4, wherein the control frame comprises a first set of cells corresponding to adjust a first intermediate level of the multi-level signal and a second set of cells corresponding to adjust a second intermediate level of the multi-level signal.

EXAMPLE EMBODIMENT 6. The system of example embodiment 5, wherein the first set of cells comprises a code specifying to hold, decrement, or increment the first intermediate level and the second set of cells comprises a code specifying to hold, decrement, or increment the second intermediate level.

EXAMPLE EMBODIMENT 7. The system of example embodiment 1, wherein the multi-level signal comprises a four-level signal with two intermediate levels, wherein the transceiver circuitry is configured to controllably adjust the two intermediate levels and wherein the receiver circuitry is configured to instruct the transmitter circuitry to adjust the two intermediate levels.

EXAMPLE EMBODIMENT 8. The system of example embodiment 1, wherein the receiver circuitry is configured to instruct the transmitter circuitry to adjust the levels of the multi-level signal during a link training process.

EXAMPLE EMBODIMENT 9. The system of example embodiment 1, wherein the receiver circuitry is configured to adjust the levels of the multi-level signal after adjusting a receiver input gain.

EXAMPLE EMBODIMENT 10. The system of example embodiment 1, wherein:
the transmitter circuitry is configured to controllably adjust an equalization of the transmitter circuitry;
the receiver circuitry is configured to instruct the transmitter circuitry to adjust the equalization of the transmitter circuitry; and
the receiver circuitry is configured to adjust the levels of the multi-level signal after the equalization of the transmitter circuitry is within a specification.

EXAMPLE EMBODIMENT 11. The system of example embodiment 1, wherein the transmitter circuitry is configured to adjust levels of the multi-level signal based on an adjustment to a digital code used to define the levels of the multi-level signal.

EXAMPLE EMBODIMENT 12. The system of example embodiment 1, wherein the transmitter circuitry is configured to adjust levels of the multi-level signal based on adjusting a look-up-table used to encode the multi-level signal.

EXAMPLE EMBODIMENT 13. A method comprising:
receiving a multi-level signal from a transmitter via a communication link; measuring an eye symmetry of the multi-level signal; and
issuing a request to the transmitter to adjust an intermediate voltage level of the multi-level signal at the transmitter.

EXAMPLE EMBODIMENT 14. The method of example embodiment 13, wherein the method is performed during link training.

EXAMPLE EMBODIMENT 15. The method of example embodiment 13, comprising, before issuing the request to the transmitter to adjust the intermediate voltage level of the multi- level signal:
performing an adjustment to the multi-level signal at the receiver; and
issuing a request to the transmitter to perform equalization at the transmitter.

EXAMPLE EMBODIMENT 16. The method of example embodiment 15, comprising, after issuing the request to the transmitter to adjust the intermediate voltage level of the multi-level signal:
performing another adjustment to the multi-level signal at the receiver; and
issuing another request to the transmitter to perform equalization at the transmitter.

EXAMPLE EMBODIMENT 17. The method of example embodiment 13, wherein the method is at least partly performed using system management circuitry of the receiver.

EXAMPLE EMBODIMENT 18. An integrated circuit device comprising:
receiver circuitry to receive an analog multi-level signal over a communication link from a transmitter;
an analog-to-digital converter to convert the received analog multi-level signal to a received digital version of the multi-level signal; and
system management circuitry to instruct the transmitter to adjust an intermediate voltage level of the analog multi-level signal at the transmitter based on an eye symmetry of the received digital version of the multi-level signal.

EXAMPLE EMBODIMENT 19. The integrated circuit device of example embodiment 18, wherein the system management circuitry is configured to instruct the transmitter to adjust the intermediate voltage level during link training.

EXAMPLE EMBODIMENT 20. The integrated circuit device of example embodiment 18, wherein the system management circuitry is configured to instruct the transmitter to adjust transmitter equalization before instructing the transmitter to adjust the intermediate voltage level.

What is claimed is:

1. A system comprising:
a first integrated circuit device comprising transmitter circuitry configured to controllably adjust levels of a multi-level signal and transmit the multi-level signal over a communication link; and
a second integrated circuit device comprising receiver circuitry configured to receive the multi-level signal and instruct the transmitter circuitry to adjust the levels of the multi-level signal.

2. The system of claim 1, wherein the receiver circuitry is configured to instruct the transmitter circuitry to adjust the levels of the multi-level signal based on an eye symmetry of the multi-level signal as received by the receiver circuitry.

3. The system of claim 1, wherein the receiver circuitry is configured to instruct the transmitter circuitry to adjust the levels of the multi-level signal using an increment or decrement signal to instruct the transmitter circuitry to increment or decrement an intermediate level of the multi-level signal.

4. The system of claim 1, wherein the receiver circuitry is configured to transmit a control frame to the transmitter to instruct the transmitter circuitry to adjust the levels of the multi-level signal.

5. The system of claim 4, wherein the control frame comprises a first set of cells corresponding to adjust a first intermediate level of the multi-level signal and a second set of cells corresponding to adjust a second intermediate level of the multi-level signal.

6. The system of claim 5, wherein the first set of cells comprises a code specifying to hold, decrement, or increment the first intermediate level and the second set of cells comprises a code specifying to hold, decrement, or increment the second intermediate level.

7. The system of claim 1, wherein the multi-level signal comprises a four-level signal with two intermediate levels, wherein the transceiver circuitry is configured to controllably adjust the two intermediate levels and wherein the receiver circuitry is configured to instruct the transmitter circuitry to adjust the two intermediate levels.

8. The system of claim 1, wherein the receiver circuitry is configured to instruct the transmitter circuitry to adjust the levels of the multi-level signal during a link training process.

9. The system of claim 1, wherein the receiver circuitry is configured to adjust the levels of the multi-level signal after adjusting a receiver input gain.

10. The system of claim 1, wherein:
the transmitter circuitry is configured to controllably adjust an equalization of the transmitter circuitry;
the receiver circuitry is configured to instruct the transmitter circuitry to adjust the equalization of the transmitter circuitry; and
the receiver circuitry is configured to adjust the levels of the multi-level signal after the equalization of the transmitter circuitry is within a specification.

11. The system of claim 1, wherein the transmitter circuitry is configured to adjust levels of the multi-level signal based on an adjustment to a digital code used to define the levels of the multi-level signal.

12. The system of claim 1, wherein the transmitter circuitry is configured to adjust levels of the multi-level signal based on adjusting a look-up-table used to encode the multi-level signal.

13. A method comprising:
receiving a multi-level signal from a transmitter via a communication link;
measuring an eye symmetry of the multi-level signal; and
issuing a request to the transmitter to adjust an intermediate voltage level of the multi-level signal at the transmitter.

14. The method of claim 13, wherein the method is performed during link training.

15. The method of claim 13, comprising, before issuing the request to the transmitter to adjust the intermediate voltage level of the multi-level signal:
performing an adjustment to the multi-level signal at the receiver; and
issuing a request to the transmitter to perform equalization at the transmitter.

16. The method of claim 15, comprising, after issuing the request to the transmitter to adjust the intermediate voltage level of the multi-level signal:
performing another adjustment to the multi-level signal at the receiver; and
issuing another request to the transmitter to perform equalization at the transmitter.

17. The method of claim 13, wherein the method is at least partly performed using system management circuitry of the receiver.

18. An integrated circuit device comprising:
receiver circuitry to receive an analog multi-level signal over a communication link from a transmitter;
an analog-to-digital converter to convert the received analog multi-level signal to a received digital version of the multi-level signal; and
system management circuitry to instruct the transmitter to adjust an intermediate voltage level of the analog multi-level signal at the transmitter based on an eye symmetry of the received digital version of the multi-level signal.

19. The integrated circuit device of claim 18, wherein the system management circuitry is configured to instruct the transmitter to adjust the intermediate voltage level during link training.

20. The integrated circuit device of claim 18, wherein the system management circuitry is configured to instruct the transmitter to adjust transmitter equalization before instructing the transmitter to adjust the intermediate voltage level.
